(19) United States
(12) Patent Application Publication
(10) Pub. No.: US 2026/0365139 A1
(43) Pub. Date: Nov. 19, 2026

(54) ACCESS CONTROL DEVICE FOR A VEHICLE, VEHICLE, RADIO KEY, AND METHOD FOR OPERATING AN ACCESS CONTROL DEVICE

(71) Applicant: AUMOVIO Germany GmbH, Frankfurt am Main (DE)

(72) Inventor: Stefan Hammes, Regensburg (DE)

(73) Assignee: AUMOVIO Germany GmbH, Frankfurt am Main (DE)

(21) Appl. No.: 19/676,183

(22) Filed: May 13, 2026

(30) Foreign Application Priority Data
May 13, 2025 (DE) 10 2025 118 313.9

(51) Int. Cl. B60R 25/24; B60R 25/102

(52) U.S. Cl. CPC B60R 25/245; B60R 25/102

(57) ABSTRACT

The disclosure relates to a radio-based access control device for a vehicle. The radio-based access control device is configured to perform an unlocking method using a radio key coupled to the radio-based access control device, wherein the unlocking method comprises a locating method for locating the radio key, and to enable at least one vehicle function if an unlocking condition comprising a locating condition being met is met. The radio-based access control device is configured to block the coupled radio key for a predetermined minimum duration for further performance of the locating method if a blocking criterion is met by the coupled radio key. The disclosure provides that the radio-based access control device is configured to send a blocking signal to the coupled radio key when the blocking criterion is met by the coupled radio key.

### CROSS-REFERENCE TO RELATED APPLICATIONS

This U.S. patent application claims the benefit of German application No. 10 2025 118 313.9, filed on May 13, 2025, which is hereby incorporated by reference.

### TECHNICAL FIELD

The disclosure relates to an access control device for a vehicle, a vehicle comprising an access control device, a radio key, and a method for operating an access control device.

### BACKGROUND

Modern access control devices for vehicles are configured to carry out radio-based unlocking methods. This allows a bearer of a radio key to unlock a door of the vehicle via a remote control, for example.

The unlocking of the door by the access control device presumes that the radio key is successfully authenticated by the access control device in an unlocking method. In addition, it is normally necessary for the radio key to be located in a predefined local area in the immediate surroundings of the vehicle for unlocking the door. Locating the radio key comprises, for example, in order to avert a so-called relay station attack, reception of signals of the radio key in the ultra-wideband range (UWB) by multiple transceivers of the access control device, which are arranged at different positions on the vehicle. By comparing time of flight differences of the signals received by the transceivers it is possible to determine the position of the emitting radio key.

The unlocking method can be initiated manually by the bearer of the radio key by pressing a button on the radio key, whereupon the key initiates a signal to the access control device to initiate the unlocking method. To increase the ease of use, the unlocking method is increasingly being initiated automatically if, for example, the access control device establishes that the radio key is in the vicinity of the vehicle. Alternatively, the radio key/smart device can also initiate locating by way of motion detection. A disadvantage of this approach is that the unlocking method can also be initiated by the bearer unintentionally when moving in the surroundings of the vehicle. Therefore, this can have the result that multiple unlocking methods are performed unintentionally within a certain period of time, without a door of the vehicle actually being opened by the bearer. The locating method in particular is relatively energy-intensive and strains the batteries both of the vehicle and the radio key. An unlocking method that is performed unintentionally generally differs from an intentionally performed unlocking method due to a failure to use a function unlocked by the unlocking method. Such an unused performed unlocking method is, for example, one which is performed and successfully completed without a door actually being opened within a specific period of time, for example.

To conserve the battery, it is therefore common for the radio key in question to be blocked for further locating processes at least for a determined period of time if a certain number of unlocking methods are performed unused within a period of time. This can result in an unlocking method intended by the wearer not being able to be performed and the wearer therefore not gaining access to the vehicle without knowing the reasons for the refusal of entry.

### SUMMARY

It is therefore an object of the present disclosure to make blocking of a radio key by an access control device comprehensible.

This object is achieved by the subjects of the independent claims. Advantageous refinements of the disclosure are disclosed by the dependent patent claims, the description, and the figures.

A first aspect of the disclosure relates to a radio-based access control device for a vehicle. The radio-based access control device can be a so-called keyless system, which permits unlocking of the vehicle or enabling of vehicle functions by a radio key. The radio key can be a dedicated radio key or a smart device, such as a smartphone, a smartwatch, or another user terminal, for example, which is coupled to the access control device for unlocking the vehicle.

The radio-based access control device is configured to perform an unlocking method using the radio key coupled to the radio-based access control device, wherein the unlocking method comprises a locating method for determining a current position of the radio key. In other words, the access control device is coupled to a radio key. The coupling of the radio key to the access control device can comprise the assignment of a shared secret, for example a symmetric key or an asymmetric key pair, which is used to perform a mutual authentication protocol. By the coupled radio key, it is possible to unlock the vehicle or to enable certain functions of the vehicle. The unlocking method can comprise, for example, authenticating the key with respect to the access control device. The unlocking method comprises a locating method in order to determine a position of the radio key in relation to the vehicle. The position of the radio key can be determined on the basis of time-of-flight (ToF) measurements, triangulation, or other locating-based methods. For this purpose, the radio-based access control device uses transceivers to receive and analyze radio signals from the key. The current position of the radio key relative to the vehicle is determined on the basis of a signal strength (RSSI), the time-of-flight (ToF), or the angle determination (AoA).

The radio-based access control device is configured to enable the at least one vehicle function if an unlocking condition is met. The unlocking condition comprises that a locating condition is met. The locating condition can be met if the radio key is localized within a defined area around the vehicle while performing the unlocking process. It can be provided, for example, that an unlocking method for unlocking a vehicle door requires the radio key to be localized in an area in front of the relevant vehicle door.

The radio-based access control device is configured to block the coupled radio key for further locating methods for a predetermined minimum duration if a blocking criterion is met by the coupled radio key in the unlocking method. In other words, a blocking criterion is specified in the access control device. The blocking criterion is defined such that it is triggered when a specific impermissible number of unused unlocking methods is performed using the coupled radio key. The goal of blocking of the coupled radio key is to avoid unnecessary locating methods and in this way to conserve a battery of the radio key and/or of the vehicle. The minimum duration of the blocking can last, for example, seconds, minutes, or hours.

During the blocking duration of the coupled radio key, the access control device prevents any initiation of locating methods for this radio key. As a result, meeting the predefined locating conditions can no longer be validated by the access control device, which prevents the enabling of certain vehicle functions via the radio key until the blocking is lifted.

The access control device is designed such that it transmits a blocking signal to the relevant coupled radio key when the blocking criterion is met. This blocking signal can trigger a notification on the radio key, this can be carried out, for example, by optical displays, haptic vibration, or acoustic signals. This can inform the user about the blocked state and enables the user to distinguish between an actual defect of the radio key or of the access control device and an intentional blocking of the locating function for the radio key by the access control device.

The disclosure also comprises refinements that result in further advantages.

One refinement of the disclosure provides that the blocking signal comprises the duration of the blocking. In other words, the duration of the blocking or a time up to which the radio key is blocked is communicated to the radio key by the blocking signal. The radio key can be configured to indicate to the bearer of the radio key when the blocking is lifted by the access control device. The blocking signal accordingly comprises not only the information about the blocking, but also the remaining duration until the blocking is lifted. The radio key can, for example, be able to communicate the duration to the user visually or acoustically. The bearer can also be instructed by the radio key on how he can lift the block.

One refinement of the disclosure provides that the blocking signal comprises a blocking status of at least one further coupled radio key. In other words, the blocking signal can contain information indicating whether and for how long at least one further one of the coupled radio keys is blocked. The blocking signal can also indicate which of the coupled radio keys are enabled. This results in the user learns which radio keys he can use as an alternative to perform the unlocking method.

One refinement of the disclosure provides that the radio-based access control device is configured to lift the blocking of the coupled radio key upon receiving an unblocking signal. The unblocking signal can be provided by the blocked coupled radio key itself or a further coupled radio key or a server, for example. The unblocking signal can comprise an identifier for identifying the radio key to be unblocked. It can be provided, for example, that the blocked radio key is configured to emit the unblocking signal when a predetermined user input is detected at the radio key. For example, the radio key can be configured to display its blocking on a screen by way of a flashing LED of the radio key or a display on a display screen when the blocking signal is received, and at the same time to be set to detect a predefined gesture or a predefined actuation of a button. The refinement results in the user is given the option of lifting the blocking of the coupled radio key again when the blocking time has elapsed.

One refinement of the disclosure provides that the radio-based access control device is configured to abandon the blocking of the coupled radio key when a predefined user action is detected. In other words, the radio-based access control device offers the possibility of unlocking the coupled radio key by the predetermined user action. It can be provided, for example, that the access control device has an input element that allows the blocking of the radio key to be lifted. It could also be provided that the access control device can capture the specific user action on the vehicle, for example, a pull on the door handle of the vehicle by the bearer within a particular time window.

One refinement of the disclosure provides that the access control device is configured to transmit a warning signal to the coupled radio key if a predetermined warning criterion is met by the coupled radio key. The warning criterion is selected such that it describes an approximation of the impermissible number of unlocking methods performed unused using the coupled radio key. It can be provided, for example, that the radio key is blocked when a certain number of unused unlocking methods are performed. In order to give the user the possibility of avoiding blocking the radio key, it can be provided that for a certain number of unused unlocking methods that is smaller than the number of unused unlocking methods that meets the blocking criterion, the warning signal is emitted to the coupled radio key. The radio key can in this case output a user output, which gives the user the opportunity to change his actions or to change the position of the radio key in order to avoid blocking of the radio key by the access control device.

A second aspect of the disclosure relates to a vehicle comprising a radio-based access control device according to the first aspect of the disclosure. The vehicle can be designed in particular as a passenger vehicle or a truck. The access control device can be provided to enable access to the vehicle upon successful completion of an unlocking method and, for example, to unlock a door.

The radio-based access control device is configured to perform an unlocking method using a radio key coupled to the radio-based access control device, which unlocking method comprises a locating method for locating the radio key, and to enable at least one vehicle function if an unlocking condition that requires a locating condition to be met. The radio-based access control device is configured to block the coupled radio key for a predetermined minimum duration for further locating methods if a blocking criterion is met by the coupled radio key. The blocking criterion relates to an impermissible number of unlocking methods performed unused using the coupled radio key.

It is provided that the radio-based access control device is configured to send a blocking signal to the coupled radio key when the blocking criterion is met by the coupled radio key.

A third aspect of the disclosure relates to a radio key for a radio-based access control device according to the first aspect of the disclosure. The radio key is configured to receive a blocking signal from the coupled access control device. The radio key is configured to output a predetermined user output upon receiving the blocking signal in order to inform the user about the blocking. This user output can be for example a visual indication, an audible signal, or a haptic feedback.

A fourth aspect of the disclosure relates to a method for operating a radio-based access control device according to the first aspect of the disclosure.

In the method, the radio-based access control device establishes that a blocking criterion is met by a radio key coupled to the radio-based access control device. The coupled radio key is subsequently blocked for further locating methods for locating the radio key in an unlocking method for a predetermined minimum duration. In addition, when the blocking criterion is met by the coupled radio key, the radio-based access control device sends a blocking signal to the coupled radio key.

In order to perform the described steps, a processor circuit can be provided for the access control device, which has programming or software comprising program instructions which, when the processor circuit executes the program instructions, prompts it to perform an embodiment of the method. For this purpose, the processor circuit can have at least one microprocessor and/or microcontroller. The program instructions can be stored in a data memory of the processor circuit.

The disclosure also includes refinements of the vehicle according to the disclosure, the radio key according to the disclosure, and the method according to the disclosure which have features as have already been described in connection with the refinements of the access control device according to the disclosure. For this reason, the corresponding refinements of the vehicle according to the disclosure, the radio key according to the disclosure, and the method according to the disclosure are not described again here.

For use cases or application situations which can result during the method and which are not explicitly described here, it can be provided that an error message and/or a request to input a user feedback is output and/or a default setting and/or a predetermined initial state is set according to the method.

The disclosure also comprises the combinations of the features of the described embodiments.

### BRIEF DESCRIPTION OF THE DRAWINGS

In the following, an exemplary embodiment of the disclosure will be described. In the figures:

FIG. 1 shows a schematic representation of a vehicle that has a radio-based access control device;

FIG. 2 shows a further schematic representation of a vehicle that has a radio-based access control device; and

FIG. 3 shows a schematic representation of a sequence of a method for operating an access control device.

### DETAILED DESCRIPTION

The exemplary embodiment explained below is a preferred embodiment of the disclosure. In the exemplary embodiment, the described components of the embodiment each represent individual features of the disclosure to be considered independently of one another, and that each also refine the disclosure independently of one another and can therefore also be considered to be part of the disclosure individually or in a combination other than that shown. Furthermore, the embodiment described can also be supplemented by further features of the disclosure that have already been described.

In the figures, functionally-identical elements are each provided with the same reference numeral.

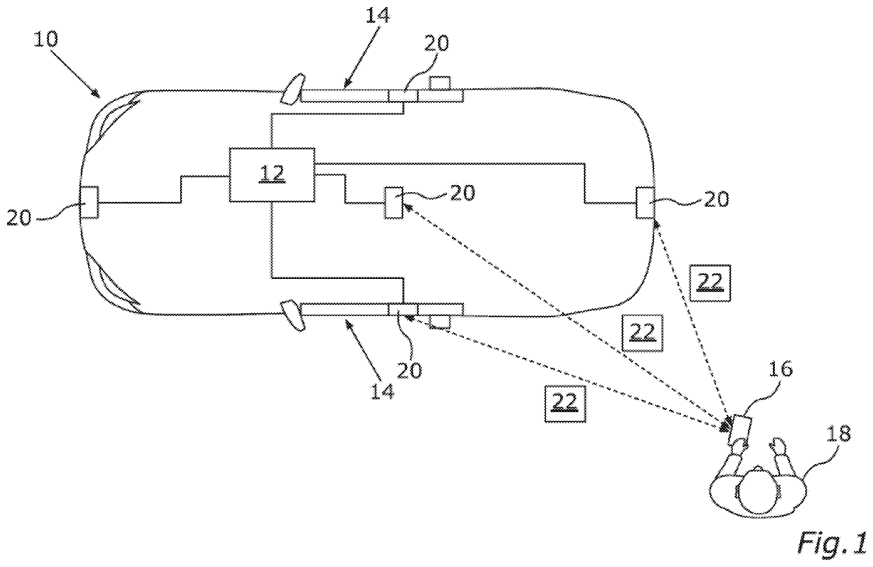

FIG. 1 shows a schematic representation of a vehicle 10 that has a radio-based access control device 12.

The vehicle 10 can be configured as a passenger vehicle, for example. The radio-based access control device 12 can be configured to unlock doors 14 of the vehicle 10 or to enable functions of the vehicle 10. The unlocking can take place after a successfully completed unlocking method using radio keys 16 that are coupled to the access control device 12.

The successful conclusion of the unlocking method can require it to be established in a locating method that the radio key 16 meets a locating condition. It can be necessary, for example, for the radio key 16 to be in a predetermined local area in front of a door 14 of the vehicle 10. The radio-based access control device 12 can comprise multiple transceiver units 20 which can be arranged at predefined positions on the vehicle 10 to perform the locating method. The transceiver units 20 can be configured to emit and receive UWB signals 22. The radio-based access control device 12 can be configured to determine distances between the coupled radio key 16 and the respective transceiver units 20 and to determine a current position of the radio key 16 in relation to the vehicle 10 based on the determined distances.

The radio-based access control device 12 can be configured to initiate the unlocking method if a certain movement is detected in front of a door 14 of a front hatch or rear hatch of the vehicle 10, which indicates an intention of the user 18 to access the vehicle 10. However, it can be possible for the detected movement to not be triggered by the user 18 but, for example, by another person, an animal, or in the event of contact with a wet bush in the case of a capacitive door handle sensor. If the radio key 16 is in surroundings of the vehicle 10, it is located by the radio-based access control device 12 in the locating method. In order to conserve batteries, it can be provided that the coupled radio key 16 is blocked for further locating methods at least for a predetermined minimum duration if a blocking condition is met. This can have the result that, if the vehicle 10 is intended to be unlocked by the user 18 within the duration of the blocking, this is not possible.

According to the current prior art, the user 18 does not learn about the blocking of the radio key 16 for the locating method and consequently cannot recognize that the unlocking method is not being performed due to the blocking.

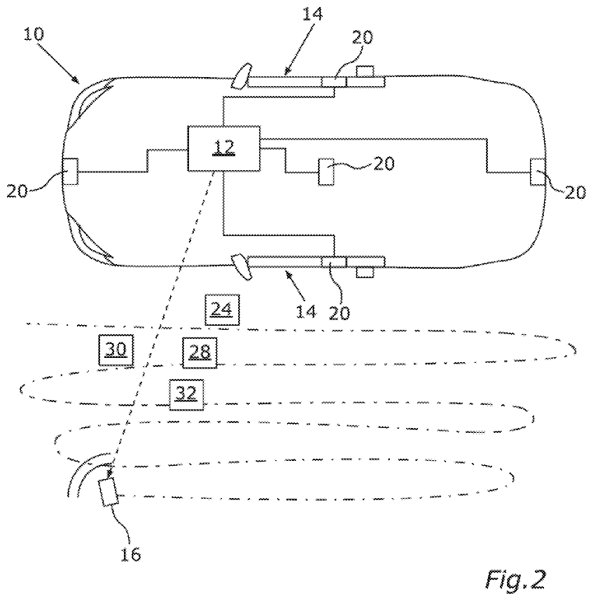

FIG. 2 shows a further schematic representation of a vehicle 10 that has a radio-based access control device 12.

The radio key 16 can be carried by the user 18 of the vehicle 10, who can move along the line shown in surroundings of the vehicle 10. Due to the movement of the radio key 16 in the vicinity of the vehicle 10, the unlocking method can be unintentionally initiated multiple times and the position of the radio key 16 can be located. However, an opening of a door 14 by the user 18 may not occur, so that the unlocking method can fail multiple times. In order to save energy, the unlocking device can block the coupled radio key 16. It can be provided that a warning condition is met before the blocking, for example, due to a specific number of failed unlocking processes, and a warning signal 24 is transmitted to the radio key 16 by the radio-based access control device 12. The warning signal 24 can be transmitted to the coupled radio key 16 via Bluetooth, for example. Upon reception, this key can output a user output 26, for example an acoustic, optical, or haptic user output 26. If a further specific number of failed unlocking processes is exceeded, the blocking condition can be met and the coupled radio key 16 can be blocked by the unlocking device.

Upon blocking, the unlocking device can transmit a blocking signal 28 to the radio key 16. The blocking signal 28 can inform the radio key 16 about its blocking and describe a duration of the blocking. Upon receiving the blocking signal 28, the radio key 16 can output a user output 26, for example an audible, optical, or haptic user output 26. The duration of the blocking can be displayed on a display of the radio key 16, for example, or by a flashing sequence of an LED of the radio key 16. In order to allow unblocking of the radio key 16, it can be provided that the radio key 16 is configured to capture a predetermined user input or action of the user 18 and thereupon to transmit to the access control device 12 an unblocking signal 30 which can enable the radio key 16 to perform the locating method again. Upon receiving the unblocking signal and the radio key 16 having been enabled, the access control device 12 can send a confirmation signal 32 to the radio key 16.

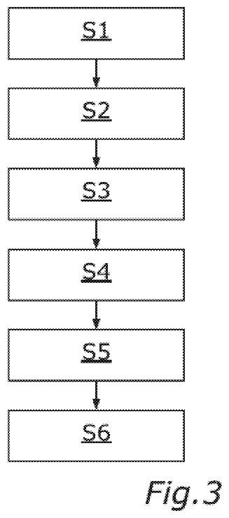

FIG. 3 shows a schematic representation of a sequence of a method for operating an access control device 12.

In first step S1, the radio-based access control device 12 of the vehicle 10 can use the coupled radio key 16 to start an unlocking method. In the context of this unlocking method, the position of the radio key 16 can be determined in a locating method in order to establish whether the radio key 16 is in a predefined area close to the vehicle 10 and therefore meets a location condition. The unlocking method can be unintentionally triggered by movements in the vicinity of the vehicle 10. In this case, the radio key 16 is located, but the door 14 is not opened. The radio-based access control device 12 can detect failed unlocking attempts within a certain period of time and can block the radio key 16 as soon as a predefined number is reached, in order to conserve the batteries of radio key 16 and vehicle 10.

A preceding failed unlocking attempt can result in the blocking condition being met, and the radio key 16 is, in a second step S2, blocked for further locating methods for a specific blocking time.

The unlocking operation can additionally transmit, in a step S3, a blocking signal 28 to the coupled radio key 16, for example, by Bluetooth, in order to inform the latter about its block.

The radio key 16 can receive the blocking signal 28 and output a user output 26 that can alert S4 the user 18 to the blocking. The radio key 16 can display a duration of the blocking and an instruction for a predetermined user input which results in the radio key 16 transmitting an unblocking signal 30 to the radio-based access control device 12.

For example, the radio key 16 can detect, as the predetermined user input, in a step S5 that a particular key is actuated in a predetermined number and can then transmit the unblocking signal 30 to the radio-based access control device 12.

The radio-based access control device 12 can receive the unblocking signal 30 in a step S6 and transmit a confirmation signal 32 to the radio key 16 in order to inform the radio key 16 of successful unblocking.

To unlock a radio-based access control device 12, it can be coupled to a radio key 16. The radio key 16 can be a dedicated key for a vehicle 10 or a smart device such as a smartphone or a smartwatch. In the context of an unlocking method, the radio key 16 is located. The localizing of a radio key 16 coupled to a radio-based access control device 12 by means of UltraWideBand (UWB) consumes a relatively large amount of energy. Therefore, vehicles 10 that locate radio keys 16 via UWB normally use a form of “play protection” which is intended to be used to limit excessive localization attempts. However, this game protection ultimately results in the radio key 16 being blocked, that is to say a radio key 16 that is blocked by the game protection does not trigger any further locating methods on the part of the access control device 12. However, this is not recognizable to the user 18 of the smart device. The object of this disclosure is to inform the user 18 that the radio key 16 is blocked on the part of the vehicle 10. In addition, the user 18 is instructed as to how the blocking of the radio key 16 can be lifted or how the game protection can be completely deactivated. At present, the user 18 is not informed about the blocking of his radio key 16. As a rule, there is only one corresponding passage in the operating instructions for the vehicle 10.

Immediately before the vehicle 10 blocks a radio key 16 for further localization attempts using a game protection algorithm, it sends an appropriate message to the radio key 16, for example via Bluetooth. This message contains the information about the blocking, as well as other details such as the duration of the blocking and how it can be lifted. This message transmission is generally possible without any problems, since the game protection algorithm normally evaluates how often the radio key 16 has been in direct proximity to the vehicle 10 without triggering a vehicle function (for example, the opening of a door 14). This means that the radio key 16 is connected to the vehicle 10 via radio at the time the game protection is triggered. The radio key 16 can now inform the user 18 that it has been blocked by the vehicle 10. Furthermore, the radio key 16 can inform the user 18 about how the blocking can be lifted. This is important because vehicle producers use different methods to lift such blocking caused by the game protection. In addition, the radio key 16 can instruct the user 18 to configure the game protection differently or even to deactivate it completely. Furthermore, the vehicle 10 can communicate to the radio key 16 which other radio keys 16 coupled to the access control device 12 are currently blocked by the game protection.

Overall, the example shows how a notification of a blocking of a radio key that has taken place can be provided.

1. A radio-based access control device for a vehicle
wherein
the radio-based access control device is configured to perform an unlocking method using a radio key coupled to the radio-based access control device, wherein the unlocking method comprises a locating method for locating the radio key, and to enable at least one vehicle function if an unlocking condition comprising a locating condition being met is met; and
the radio-based access control device is configured to block the coupled radio key for a predetermined minimum duration for further performance of the locating method if a blocking criterion is met by the coupled radio key, wherein the blocking criterion specifies an impermissible number of unused unlocking methods performed using the coupled radio key;
wherein the radio-based access control device is configured to send a blocking signal to the coupled radio key when the blocking criterion is met by the coupled radio key.

2. The radio-based access control device as claimed in claim 1, wherein the blocking signal indicates the duration of the blocking.

3. The radio-based access control device as claimed in claim 1, wherein the blocking signal comprises a blocking status of at least one further coupled radio key.

4. The radio-based access control device as claimed in claim 1, wherein the radio-based access control device is configured to lift the blocking of the coupled radio key upon receiving an unblocking signal.

5. The radio-based access control device as claimed in claim 1, wherein the radio-based access control device is configured to lift the blocking of the coupled radio key upon detecting a predetermined user action.

6. The radio-based access control device as claimed in claim 1, wherein the radio-based access control device is configured to send a warning signal to the coupled radio key by the coupled radio key when an advance warning criterion that specifies an approach to the impermissible number of unused performed unlocking methods using the coupled radio key is met.

7. A radio key for a radio-based access control device,
wherein
the radio key is configured to receive a blocking signal from a radio-based access control device coupled to the radio key and to output a predetermined user output upon reception of the blocking signal.

8. A method for operating a radio-based access control device for a vehicle, the method comprising:
detecting that a blocking criterion is met, which specifies an impermissible number of unlocking methods performed unused using the coupled radio key, by a radio key coupled to the access control device in an unlocking method;
blocking the coupled radio key for a predetermined minimum duration for locating methods of the access control device for locating the radio key in an unlocking method; and
sending a blocking signal to the coupled radio key.
